(19) United States
(12) Patent Application Publication
(10) Pub. No.: US 2005/0104725 A1
(43) Pub. Date: May 19, 2005

(54) Remote-control method and device

(76) Inventor: Stephane Leguillier, Puteaux (FR)

Correspondence Address: PERMAN & GREEN, 425 POST ROAD, FAIRFIELD, CT, 06824, US

(21) Appl. No.: 10/840,004

(22) Filed: May 6, 2004

(30) Foreign Application Priority Data
May 19, 2003 (FR) 03 50159

(51) Int. Cl. G08B 1/00

(52) U.S. Cl. 340/531; 710/105; 375/220; 340/825; 455/90.1

(57) ABSTRACT

To achieve greater universality for a remote control of a transmitter by a non-specified receiver linked with this transmitter, it is planned to interpose an alarm message server between, them. The alarm message server can thus play a command message server role. The alarm message server interprets the alarm messages received from the transmitter and transmits them to the receiver, knowing the capability of this receiver to receive these messages. It is shown that, with this mode of action, it is enough for a non-specified receiver to get connected to the alarm message server, during a first operation, to use a pre-prepared procedure to designate the transmitter with which it subsequently wishes to be able to get linked and to be capable of controlling the transmitter regardless of its class. In particular, the disclosed method removes the obligation to specialize the transmitter-receiver link.

### BACKGROUND OF THE INVENTION

1. Field of the Invention

An object of the present invention is a remote-control method and device. The invention is aimed essentially at facilitating the use of alarm message transmitters, the term “alarm message” being understood in the general sense of the reporting of a useful piece of information to a recipient either when the occasion arises or on a regular basis. The remote-control operation in question comprises a control message or command message in response to the alarm message. The command message is sent by the receiver to the transmitter, or to peripherals connected to this transmitter, so that it executes one or more actions corresponding to the command message.

2. Description of the Prior Art

In the field of remote surveillance and monitoring, there are thus known devices in which a transmitter automaton transmits information to a receiver according to a proprietary protocol. For example, especially in the field of the protection of buildings, a transmitter may include an intrusion detector and the sending of an alarm message to the receiver. The alarm message may comprise an image detected by a camera of the transmitter and intended for the receiver. A transmitter of this type is described for example in the document FR-A-2 817 989. This document also provides for a remote-control system for the transmitter by which it is made to send back other images and/or sounds, pertaining to the detected alarm, to the receiver.

In another field, there are known remote-control systems comprising especially the operations of sending alarm and control signals between a transmitter and a receiver along specific transmission channels. These channels may comprise transmission according to the BLUE-TOOTH standard and the sending of images or of messages in mobile telecommunications according to the MMS protocol.

Whatever the solutions chosen, these remote-control operations necessitate specialization, especially in the receiver, so that it can understand the messages that are sent to it by the transmitter and so that the transmitter can be controlled in retum. In particular, an operating system of the receiver, especially when it includes a mobile telephone, must include sub-programs by which the encoded messages that the transmitter sends to the user can be translated in a manner that can be understood by the user. In practice for example it is not possible to divert the alarm messages sent by the transmitter to any other non-specific receiver (for example another fixed or mobile telephone). This non-specific would be incapable of understanding the messages and naturally would not enable the user of the receiver to exploit them. Ultimately, the non-specific character of the receiver hampers the use of a remote-control system of this kind. It is necessary for the receiver to be specialized.

It is an aim of the invention to enable the use of the remote-control system with any non-specific receiver, especially a receiver that might be different at a subsequent date, whatever the developments and modifications undergone by said receiver.

One way to overcome the problem mentioned above would be to make a universal type of transmitter capable of sending messages adapted to any receiver whatsoever. However, apart from the fact that such an arrangement makes the transmitter particularly complicated (and costly), it would be ill-suited to the existence of new generations of receivers not foreseen for the transmitter.

In the invention, it is planned to overcome this drawback by interposing a server of alarm messages in the remote-control chain, between the transmitter and the receiver. This alarm message server receives the alarm messages and interprets them according to the characteristics of the receiver, before sending these interpreted alarm messages to the receiver. To this end, the alarm message receiver comprises a database, especially tables indicating, inter alia, firstly a transmitter identity and, secondly, a receiver identity that are mated or matched by the alarm message server.

It will be shown besides that, according to the invention, it is possible to provide for a command message interpretation in retum, should the receiver need to spontaneously achieve remote control over the transmitter. Ultimately, the interpretation of the alarm message comprises the incorporation into this message of information on instructions executable by the transmitter and simply selectable by the receiver. It is then up to the alarm message server to convert itself into a command message server in order to send the transmitter instructions corresponding to the selected command. This mode of action makes the installation particularly efficient and universal.

In both cases, the only destination address known to the transmitter and the receiver are the alarm message server and the command message server respectively. This server, for its part, performs the indirect routing, namely the ultimate transmission of messages to one or more recipients indicated to it beforehand or declared for the party calling it.

One possible application of this installation is the assembling of the transmitter (which would then comprise a mobile terminal) in an automobile where the alarm detector is an intrusion detector associated with a camera pointed toward the driver of the vehicle. The alarm message can then be transmitted, through the alarm message server of the invention, to any receiver whatsoever, preferably provided with a screen and at least selection means. A user of this receiver can then make a selection, among possible commands, especially of a command used to stop the vehicle, possibly after the sending of an alarm message to the driver of the vehicle informing him that the vehicle will be stopped. The selection by the receiver of any one of the possible options, prompts this receiver to send a command, intended for the transmitter, to the command message server, and then prompts the command message server to send this message to the transmitter. A peripheral of this transmitter can then cut off the motor of the automobile.

Hereinafter in the description, the term “transmitter” shall be applied to the device that edits and sends the alarm message, and the term “receiver” shall be applied to the device that is the ultimate recipient of this alarm message. The term “alarm message server” shall be applied to a processing device interposed in the downlink path going from the transmitter to the receiver, and the term “command message server” shall be applied to a processing device interposed in the uplink path, going from the receiver to the transmitter. The receiver is an apparatus normally at the disposal of a human operator. However, it may be a device programmed to produce commands automatically in response to the expected alarms that it receives.

### SUMMARY OF THE INVENTION

An object of the invention therefore is a remote-control method in which:
a transmitter sends a alarm message, through a telecommunications network, towards a receiver,
the receiver sends a command message in return towards the transmitter
the transmitter executes an action corresponding to a command contained in the command message,
   wherein the method comprises the following steps:
an alarm message server receives the alarm message,
the alarm message server interprets the alarm message according to the characteristics of the receiver and produces an interpreted alarm message, and
the alarm message server transmits the interpreted alarm message to the receiver.

An object of the invention is also a method of remote control in which
a transmitter sends a alarm message, through a telecommunications network, towards a receiver,
the receiver sends a command message in return towards the transmitter
the transmitter executes an action corresponding to a command contained in the command message,
   wherein the method comprises the following steps:
a command message server receives the command message,
the command message server interprets the command message according to the characteristics of the receiver and produces an interpreted command message, and
the command message server transmits the interpreted command message to the receiver.

An object of the invention is also a remote-control device comprising a transmitter provided with means for sending an alarm message, through a telecommunications network, towards a receiver, a receiver to receive this alarm message and send a command message in return towards the transmitter, the transmitter being furthermore provided with means to execute an action corresponding to a command contained in the command message, wherein it comprises an alarm message server interposed to receive the alarm message, interpret the alarm message as a function of the characteristics of the receiver, produce an interpreted alarm message, and transmit the interpreted alarm message to the receiver.

### BRIEF DESCRIPTION OF THE DRAWINGS

The invention will be understood more clearly from the following description and the accompanying figures. These figures are given purely by way of an indication and in no way restrict the scope of the invention. Of these figures:

FIG. 1 is a diagrammatic view of the remote-control method and device of the invention;

FIGS. 2a and 2b are diagrammatic views of interpreted warning and remote-control messages sent respectively by an alarm message server and a command message server of the invention.

### MORE DETAILED DESCRIPTION

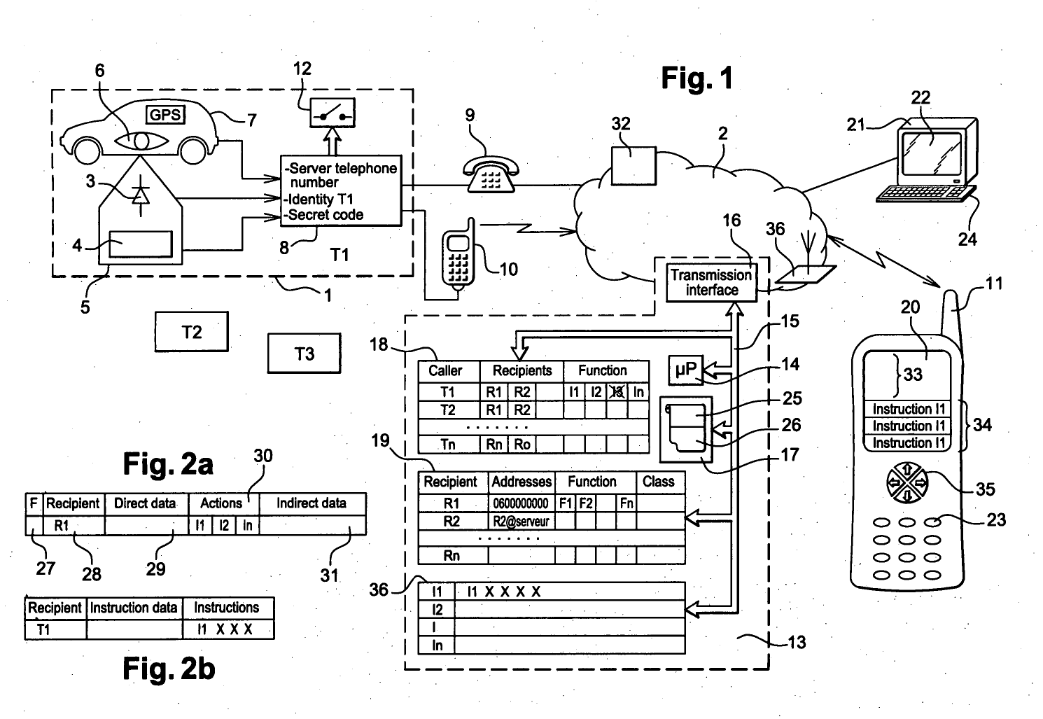

FIG. 1 shows a set of means that can be used to implement the remote-control method of the invention. These means comprise a transmitter 1 that sends an alarm message through a telecommunications network 2. The transmitter 1 may comprise an alarm detector 3 of the infrared or temperature detector type or any other type of detector 4, such as a Doppler effect radar. In general, these alarm detectors are used to measure changes in a physical parameter, and to edit a signal as soon as the value of this physical parameter crosses a threshold. The detectors 3 and 4 are chiefly designed to be installed in a private or public building 5.

In another field of use, an intrusion detector such as the detector 4 is associated with a camera 6, the entire unit being mounted in a vehicle 7, as a theft-prevention device.

The detectors 3, 4 and 6 send detection signals. They are connected to transmission circuits 8 linked with the telecommunications network 2. The transmission circuits 8 may be incorporated in or connected to telephony telecommunications installations that are fixed 9 or mobile 10. Should the transmission circuits 8 be connected to a fixed telecommunications installation 9, the transmission circuits 8 comprise especially a modem. Should a mobile terminal 10 be used, a data transmission channel of a mobile telephony protocol is preferably used.

In the prior art, for known types of specialized equipment, the transmitter 1, or else the terminals 9 and 10, comprise a designation of the receiver's address, in practice a telephone number or even an Internet address of this receiver, and means to set up a communications link with this receiver.

In the prior art, a receiver 11 too is connected to the telecommunications network 2. In a known way, it receives the messages sent by the terminals 8, 9 and 10. In correspondence with a received message, this receiver 11 may send a command to the transmitter 1 so that it produces an action, for example the activation of a switch 12 to stop the operation the engine of the vehicle 7 or cut off its power. It will be understood that such systems work well if the transmitter 1 and the receiver 11 are fully specialized and capable of communicating with each other.

In the invention, to enable non-specific transmitter 1, called T1, to converse with any type of receiver 11, called R1, it is planned that, rather than calling the receiver 11, the transmitter 1 will call a alarm message interpretation server 13. At the practical level, the server 13 comprises an information processing system. This information processing system of the server 13 comprises a processor 14 connected by bus 15 to a transmission interface 16 with the telecommunications network 2, to a program memory 17, and to a data memory comprising at least a certain number of tables specific to the invention.

Among these specific tables of the data memory, a first table 18 is used to memorize a correspondence between a calling transmitter 1, referenced by its identity T1, and a called receiver 11, referenced by its identity R1. However, if the receiver R1 is unavailable or cannot be contacted, it is possible to add on another receiver R2 as a backup, replacement or addition to R1. In this case, in the table 18, in the recording with respect to the identity T1, there is a list of recipient receivers capable of receiving alarm messages coming from the transmitter 1 with the identity T1.

Preferably, the table 18 furthermore comprises a list of available instructions in each recording. These available instructions I1, I2, . . . In are those that the transmitter T1 is capable of launching if it is remote-controlled. These instructions are, for example, instructions to cut off an engine or even, in the building 5, an instruction to activate the working of a particular extinguisher, or the shutting of remotely controllable fire doors and so on and so forth. Ultimately, the instructions executable by the transmitter 1 may be as varied and as specialized as desired. It will be shown here below that any receiver whatsoever 11 will be capable of having them executed at request.

The server 13 furthermore comprises a table 19 of the data memory in which recordings are used to set up correspondence between recipients, for example R1, places or means by which these recipients can be reached (stored in a field referenced HLR, with reference to locating databases used in mobile telephony), as well as the functions and, more generally, the classes of the recipient receivers. Ultimately, the indirect addressing of the receiver 11 is achieved by the recording, in the table 19, with reference to an identity R1 of the receiver 11, of a means of transmitting the alarm message to this receiver.

For example, if the receiver 11 is a mobile telephone, the means of linking up with it will comprise only the designation of the telephone number at which this mobile telephone can be reached. This designation is automatically associated with a session in which this number is keyed in by the server 13 to make it send the alarm message to be transmitted. However if the receiver, for example the receiver R2, is a mailbox type of receiver, the alarm message will be transferred to a message incorporated in a piece of electronic mail sent to a pre-arranged electronic address herein designated figuratively by R2@serveur. In this address, R2 designates the identity of the receiver to be linked up with and “server” designates the address of a site, especially of the Internet type, where the message can be stored until it is consulted. The stored alarm message is thus an interpreted message. Here below, we shall see how it is even more so.

In the same recordings, the different functions of the receivers shall be stored with respect to each recipient Ri. For example a function F1 corresponds to a capability of the receiver 11 to receive electronic mail (e-mail) messages. For example a function F2 corresponds to a capability of the receiver 11 to receive messages according to the MMS protocol. For example again, a function F3 relates to the fact that the receiver 11 is provided with an SIM TOOL-KIT type of, chip card. Or again a function F4 will show the ability of the receiver 11 to get connected to the Internet according to a given protocol, for example the WAP protocol. Or again a function F5 will provide information on the ability of the receiver 11 to download JAVA type applications. More concretely, a function F6 will relate to the size or a format of the screen 20 of the receiver 11, so that images can be transmitted to it in a format suited to its use. In practice, the server 13 uses these functions to interpret the alarm message, in order to put it in a format that can be understood by the non-specific receiver 11.

The filling of the table 18 may include the dispatch, during the installation of the transmitter 1, of a turning-on message by which the transmitter 1 informs the server 13 of all its characteristics, especially the available instructions I1 to In, that it is capable of executing. Preferably, it informs the server 13 of a secret code permitting future links to various receivers. Similarly, the table 19 may be filled in automatically. During the opening of a connection between a particular type of non-specific receiver 11 or non-specific receiver 21 and the server 13, these receivers send it especially their class, identity, IMSI number if it is a mobile receiver, and all the information on them, especially the means by which they can be reached: telephone number, electronic mail address or the like, and their function. The term “class” is understood to mean any piece of information by which a server can know a type of receiver (or transmitter in the case of a command message server) and retrieve all the parameters by which a message can be accurately interpreted in a table available to it, relating to this information on class.

The correspondence in a recording of the table 18 between the transmitter T1 and a given recipient R1 can easily be obtained when carrying out the recording R1 in the table 19. To this end, through the telecommunications network 2, the server 13 launches an interrogation of the receiver 11 or the receiver 21 that makes connection. This interrogation serves to ask the receiver to identify the transmitter T1 with which R1 seeks to be matched. It will be noted that this interrogation is simplified since R1, during its preliminary connection, has communicated its class to the server 13. This server 13 is therefore quite capable of sending R1 a message that R1 can understand. As it happens, the message relates to the designation, in practice the identity, of the transmitter T1 with which it must be matched.

Thus, the screen 20 of the receiver 11 or the screen 22 of the receiver 21 displays a message in which the user is requested to use the keyboards 23 or 24 respectively of these apparatuses to key in a piece of information on the identity of the transmitter T1 with which they seek to be matched. If need be, this matching may be complemented or secured by the sending of secret codes, known in the corresponding recording 18. The secret codes are furthermore keyed in with keyboards 23 or 24. If need be, the secret codes will have been communicated to the server 13 by the transmitter 1 during its installation.

In the event of agreement, the particulars of the corresponding recipients R1 are placed in the table 18 of the memory relative to the identity T1 of the concerned transmitter.

In practice, in addition to the telephone number of the server 13 to which they have to get connected, the transmission circuits 8 may include information on their identity T1 and on the secret code that can be used during the operation of matching with them. It will be noted that this matching is itself an accessible operation within the scope of any receiver 11 or 21 since, ultimately, it is the server 13 that does all the work, and is satisfied, by way of a response, with the message keyed in by the user on the keyboards 23 and 24.

The working of the server 13 according to the invention may be done in two ways, preferably the following two ways. In a first way, the program memory 17 has a sub-program 25 used to receive the alarm message from the transmitter 1, interpret it and transmit it to the receiver 11. The memory 17 may also comprise a sub-program 26 to remotely control the transmitter 1 by means of the receiver 11, spontaneously or in response to the reception of a alarm message coming from the transmitter 1.

For the sub-program 25, during the reception in the transmission interface 16 of the alarm message coming from the transmitter 1, the sub-program 25 composes an interpreted alarm message, as can be seen in FIG. 2a. This interpreted message comprises several types of information. This interpreted message comprises firstly a piece of format information, 27, in the zone F, specifying the format in which the interpreted message will be composed. In fact, the format indication is not necessarily incorporated into the interpreted message. It conditions at least the syntax of this interpreted message. For example, the format may be a data type format, or an MMS, or SMS or electronic mail type format. This format is determined according to a function, a class or even a preference mentioned by the receiver 11 having the identity R1 when it is connected to the server 13. This format information is of course complemented by an address 28, namely the address at which the recipient receiver 11 can be reached. This address of R1 is the one contained in the corresponding recording of the table 19. This recording of the address R1 is itself selected because, for the calling transmitter T1, it corresponds to the possible recipient. The calling transmitter sends an alarm signal indicating, again for this purpose, its identity in its alarm message.

Then, the interpreted alarm message has direct data 29 typically comprising information received from the transmitter 1, shaped if necessary to suit the receiver 11, especially its screen size. Then, the interpreted alarm message comprises a list of actions I1, I2, In in a field 30. These messages I1, I2, In can be executed by the transmitter 1 in response to a command to be received from the receiver 11. In practice, the actions I1, I2 and In are replaced by their reference, their identity. Their reference and identity are in fact labels that make them easy to understand by the user of the receiver 11 or 21. If necessary, the interpreted alarm message may comprise fields 31 relating to indirect data, especially site addresses (in particular Internet addresses) in which images taken by the camera 6, or other information may be stored. Preferably, this indirect data is presented to the receiver R1 in such a way that its selection by the terminal 11 immediately leads to a connection to the storage site concerned. If necessary, other information may be accessible in this indirect data such as the addresses of the fire-fighting service, the police, a security guard firm and so on. This indirect data is stored especially in a server 32 connected to the network 2 and located in this network at the address mentioned in 31.

With the type of receiver 11 being known through the preliminary entry of its class in the recording of the table 19, the server 13 is capable of formatting the interpreted alarm message so that it is displayed on the screen 20 (or screen 22) with a first information zone 33 located for example at the top of the screen and a second remote-control zone 34 located for example of the bottom of the screen. A voiced variant can also be envisaged: the information is delivered vocally before a statement and an offer of possible actions that must be selected means of DTMF keys through the keyboard 23. The zone 33 is used to display all the direct data of the zone 29 of the interpreted alarm message. The zone 34 may comprise information on the descriptions, references or identities of the instructions I1, I2 or In executable by the transmitter 1. Using a navigator button 35, the user watching the screen 20 can then select one of the instructions of the zone 34 and validate its return dispatch to the server 13. The server then transmits corresponding commands to the transmitter T1.

In practice, a table 36 of the data memory of the server 13 may comprise recordings in which instruction references, Ii, are placed in correspondence with an instruction message proper. For example, the identity instruction I1 message will be I1XXXX. The instruction message I1XXXX may be the instruction code directly executable in the transmitter 1, in correspondence with the identity instruction I1. As a variant, I1XXXX will be an indicating reference so that the transmitter 1 executes an instruction corresponding to this reference. In this case, the transmitter will comprise a processing system such as the server 13. In this case when the receiver 11 selects the instruction I1 description, the processor 14 selects the instruction message I1XXXX at the location of the instruction identity I1 in the memory 36. The server 13 then keys in an interpreted command message, shown in FIG. 2b essentially comprising the designation of a recipient, in this case the transmitter T1 and the instruction message directly executable by the transmitter T1. The command message, which too is interpreted in this way, comprises the address of the recipient, the instruction identity and preferably instruction data enabling the executable instruction to be parametrized.

It will be noted that the identity of the recipient T1 of the command message may be either incorporated into the alarm message transmitted to the receiver 11, or implicitly kept in the server 13 after the dispatch of the alarm message, pending the reception of the corresponding command message. In the latter case, the alarm message will in itself comprise an identification number. This identification number is sent by the server 13, received by the receiver 11, incorporated by the server 13 into the instruction identity in the zone 30 displayable in the zone 34, and re-sent by this receiver 11 so as to enable the unequivocal selection of the concerned instruction at the right transmitter T1.

The zone. 33 of the receiver 11 may, if this required, show a designation of the transmitter T1 that is calling it. Indeed, as shown in the first two recordings of the table 18, a receiver with the identity R2 can be linked up with several different transmitters, for example the transmitter T1 or the transmitter T2. In this case, the corresponding identity T1 or T2 is incorporated by the server 13 into the direct data.

After interpretation, naturally each of the alarm messages and/or command messages is transmitted in interpreted form to a recipient, for example, by means of a base station 36 of the network 2. From this viewpoint, the sub-program 26 is of the same type as the sub-program 25. It is used quite simply for remote control transmissions.

The present description of the tables is rather restrictive as regards the development of characteristics that it permits. As a variant, it is possible to propose a set of tables where each table is specific. For example, there could be a table of transmitters and a table of receivers, independent of each other, that could evolve (or be complemented) in the course of time (in terms of types and characteristics) and, in this case, there would be an interrelation table or device that would quite simply place them in a relationship with each other. The utility of this feature is that the system would not closed as regards the transmitters or receivers or their characteristics at a given point in time.

It will be noted that the remote-control transmissions may be spontaneous. For example, they may be regularly prompted by the server 13, without its being alerted beforehand by the transmitter 1. As a variant, the receiver 11 may possess a command to interrogate the server 13 so that the latter initializes communications with it.

As a variant, the mobile terminal 10 or the vehicle has GPS type circuits to edit a piece of information on the location of this terminal for this vehicle and transmit it to the server 13.

Depending on the class and/or specialization of the receiver 11, the command message sent by this receiver 11 may comprise instruction data to parametrize the instruction to be sent to the transmitter 1. If need be, when an instruction I1 is selected, it is provided that the receiver 11 will be interrogated again by the server 13. In this interrogation, several possible values of application will be proposed to the server for the instruction I1 thus selected.

The interpretation made by the servers is an interrogation made as a function of the recipient of the message, namely the receiver for an alarm message or the transmitter for a command message. This interpretation is, of course, also made, if need be, as a function of the sender of the message, namely the transmitter or the receiver respectively, so that the server understands the message perfectly. This interpretation of reception by the server can be made because of the reception of a piece of information on the identity of the caller, or even the reception of a piece of information of a type contained in the message coming from this caller.

It is clear that the exploitation of the invention should not be limited to the few applications mentioned here above. Thus, it could also be advantageously used in the detection of all types of malfunctions, for example, malfunctions in an elevator or in the detection of accidents or incidents in a section of motorway or again to enable effective medical monitoring in homes etc.

1. A remote-control method in which:
a transmitter sends a alarm message, through a telecommunications network, towards a receiver,
the receiver sends a command message in return towards the transmitter
the transmitter executes an action corresponding to a command contained in the command message,
wherein the method comprises the following steps:
an alarm message server receives the alarm message,
the alarm message server interprets the alarm message according to the characteristics of the receiver and produces an interpreted alarm message, and
the alarm message server transmits the interpreted alarm message to the receiver.

2. A method of remote control in which
a transmitter sends a alarm message, through a telecommunications network, towards a receiver,
the receiver sends a command message in return towards the transmitter
the transmitter executes an action corresponding to a command contained in the command message,
wherein the method comprises the following steps:
a command message server receives the command message,
the command message server interprets the command message according to the characteristics of the receiver and produces an interpreted command message, and
the command message server transmits the interpreted command message to the receiver.

3. A method according to claim 1 wherein, in the interpreted alarm message, the alarm message server incorporates, in fields, information on instructions executable by the transmitter after selection by the receiver.

4. A method according to claim 1, wherein in the interpreted alarm message, the alarm message server incorporates, in a field, an address of a site connected to a telecommunications network,
an image is stored in this site,
this image is displayed by the receiver which will seek it at this address after having received the interpreted alarm message.

5. A method according to one claim 1, wherein
the transmitter confirms an effective execution of the command.

6. A method according to claim 1, wherein
the alarm message server produces an alarm message interpreted according to the characteristics of the transmitter.

7. A method according to claim 2, wherein
the command message server produces an interpreted command message as a function of characteristics of the receiver.

8. A remote-control device comprising a transmitter provided with means for sending an alarm message, through a telecommunications network, towards a receiver, a receiver to receive this alarm message and send a command message in return towards the transmitter, the transmitter being furthermore provided with means to execute an action corresponding to a command contained in the command message, wherein it comprises an alarm message server interposed to receive the alarm message, interpret the alarm message as a function of the characteristics of the receiver, produce an interpreted alarm message, and transmit the interpreted alarm message to the receiver.

9. A remote-control device comprising a transmitter provided with means for sending an alarm message, through a telecommunications network, towards a receiver, a receiver to receive this alarm message and send a command message in return towards the transmitter, the transmitter being furthermore provided with means to execute an action corresponding to a command contained in the command message, wherein it comprises an command message server interposed to receive the command message, interpret the command message as a function of the characteristics of the receiver, produce an interpreted command message, and transmit the interpreted command message to the receiver.

10. A device according to claim 9, wherein the server comprises an information processing system with a program memory and a data memory, the data memory comprising:
a table to store points of correspondence between transmitter references and receiver references, and/or
a table to store points of correspondence between transmitter references and references of instructions executables by this transmitter, and/or
a table to store points of correspondence between receiver references and addresses (HLR) in a telecommunications network to make contact with these receivers and/or
a table to store points of correspondence between receiver references and capabilities or classes of these receivers.

11. A device according to claim 9, comprising an image server to download an image in a receiver after reception of the interpreted alarm message by this receiver.

12. A device according to claim 9, wherein the receiver comprises a mobile terminal.

13. A device according to claim 9, wherein the transmitter comprises a mobile terminal installed in an automobile vehicle, this mobile terminal being provided with means to stop the vehicle and, preferably, with a camera.

14. A device according to claim 14, wherein the transmitter comprises a GPS type circuit to incorporate an indication of the position of the vehicle in the alarm message.
